(19) United States
(12) Patent Application Publication
(10) Pub. No.: US 2026/0231037 A1
(43) Pub. Date: Aug. 6, 2026

(54) SELF-WAKEUP MODE FOR STATIONARY WIRELESS DEVICES

(71) Applicant: ResMed Inc., San Diego, CA (US)

(72) Inventor: Guorong Gordon HUANG, Poway, CA (US)

(21) Appl. No.: 19/463,543

(22) Filed: Jan. 29, 2026

Related U.S. Application Data
(60) Provisional application No. 63/752,655, filed on Feb. 1, 2025.

(51) Int. Cl. H04W 52/02; H04W 8/22; H04W 60/04; H04W 76/15

(52) U.S. Cl. CPC H04W 52/0235; H04W 8/22; H04W 60/04; H04W 76/15

(57) ABSTRACT

Certain aspects of the present disclosure provide techniques for managing power consumption in stationary wireless devices. A method for wireless communications at a network entity includes receiving a self-wakeup mode indication from a wireless device. The method includes refraining from waking up the wireless device based on the self-wakeup mode indication.

### CROSS-REFERENCE TO RELATED APPLICATIONS

This application claims priority to U.S. Provisional Application No. 63/752,655, titled METHODS AND APPARATUS FOR ENERGY-EFFICIENT MOBILE DEVICE WITH STATIONARY DETECTION AND COMMUNICATION MANAGEMENT, filed Feb. 1, 2025, which is hereby incorporated by reference in its entirety.

### BACKGROUND

### Field of the Disclosure

Aspects of the present disclosure relate to wireless communications, and more particularly, to systems, devices, methods, and techniques for managing power consumption in stationary wireless devices.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

A communication system may include a wireless communication network (such as a radio access network (RAN)) that supports communication between wireless communication devices such as network entities (such as base stations (BSs)), client devices (such as one or more user equipments (UEs)), and others. Such devices may communicate with one another using a variety of protocols (e.g., radio access technologies (RATs) that have been adopted in various telecommunication standards, which define common protocols that enable different wireless communication devices to communicate on a local, municipal, national, regional, or global level, including those of cellular-based systems such as fourth generation (4G) systems (e.g., Long Term Evolution (LTE) systems), fifth generation (5G) systems (such as 5G New Radio (5G-NR) systems), and sixth generation (6G) systems that are part of a continuous mobile broadband evolution promulgated by the Third Generation Partnership Project (3GPP). A wireless communication network may support communication by implementing system resources (such as frequency resources, time resources, spatial resources) in accordance with a wireless communication protocol.

Although wireless communications systems have made great technological advancements over many years, challenges still exist. Power consumption is an issue of high interest in technical areas associated with wireless devices, especially wireless devices that require long battery life (e.g., up to several years or even longer).

Standardized techniques to reduce the power consumption have been introduced in 3GPP technical specifications. Under 3GPP TS 38.331 v18.1.0 (2024-03), section 5.7.4.4, if a reduced capability (Redcaps) device is stationary and meets “relaxed measurement criterion for a stationary device”, the RedCap device wakes up less often to report to a network as compared to a regular (non-RedCap) device. Another approach is extended discontinuous reception (eDRX) which allows a device to have an extended “sleep” time in which the device wakes up less often. eDRX may be used by Internet-of-Things (IoT) devices to save power consumption. With these existing approaches, however, the device wakes up according to predefined network parameters.

Consequently, there exists a need for further improvements in wireless communications systems to overcome the aforementioned technical challenges and others.

### SUMMARY

One aspect provides a method for wireless communication by a network entity. The method includes receiving a self-wakeup mode indication from a wireless device. The method includes refraining from waking up the wireless device based on the self-wakeup mode indication.

One aspect provides a method for wireless communication by a wireless device. The method includes sending a self-wakeup mode indication to a network entity. The method includes independently waking up from a sleep mode.

In some aspects, a method is provided. The method includes receiving, at a network, a self-wakeup (or no-wakeup) mode indication from a device. The method includes storing, by the network, a plurality of mobility characteristics of the device. The plurality of mobility characteristics include the self-wake up mode indication. The method includes refraining, by the network, from waking up the device based on the self-wakeup mode indication of the device. The method includes receiving, by the network, another indication from the device indicating that the device has woken up. The method includes checking, by the network, for at least one of i) any stored data, ii) any information and/or iiii) at least one message pending to be sent to the device. The method includes sending, by the network, the stored information to the device. In some aspects, the network determines the plurality of mobility characteristics of the device based on a mobility behavior of the device. In some aspects, the network may further assign the device with no-wakeup or self-wakeup character based on one or more stationary mobility characteristics of the device and may provision the no-wakeup or self-wakeup character onto the device.

In some aspects, the network determines if the device meets one or more specified mobility criteria. The one or more specified mobility criteria may include relaxed measurement criterion for a stationary device. While the device is in a sleep mode, the network may store i) data, ii) information, and/or iii) one or more messages intended for the device. The network may receive another indication indicating the device has woken up fully or partially.

In some aspects, the network establishes one or more appropriate communication channels if there is i) a stored data, ii) an information, or iii) a message pending to be sent to the device after the receives the another indication. These communication channels can include at least one of i) one or more short data burst channels and ii) one or more full communication channels or sessions. The network closes the communication channels when communication is complete.

An apparatus is provided including at least one processor and at least one memory including computer program code. The memory and computer program code are configured to, with the processor, cause the apparatus to receive a self-wakeup mode (or no-wakeup) indication from a device. The memory and computer program code are configured to, with the processor, cause the apparatus to store, by the network, mobility characteristics (e.g., one or more mobility characteristics) of the device including the self-wakeup mode indication. The memory and computer program code are configured to, with the processor, cause the apparatus to refrain, by the network, from waking up the device based on the self-wakeup mode indication. The memory and computer program code are configured to, with the processor, cause the apparatus to receive, by the network, another indication from the device indicating the device has woken up. The memory and computer program code are configured to, with the processor, cause the apparatus to check, by the network for i) any stored data, ii) any information and/or iii) at least one message pending to be sent to the device. The memory and computer program code are configured to, with the processor, cause the apparatus to send, by the network, the stored information to the device. The network may store at least one of i) a data, ii) an information, and/or iii) one or more messages intended for the device while the device is in a sleep mode.

A method is provided that includes: sending, by a device, a self-wakeup mode indication to a network. The method includes waking up, by the device, independently, based on the device's own algorithm. The method includes sending, by the device, another indication to the network indicating that the device has woken up and is ready for communication, establishing communication channels between the device and the network if there is stored information at the network waiting to be sent to the device, and receiving, by the device, the stored information. The device can be pre-assigned to be stationary and can be provisioned with a self-wakeup character that is i) built-in in a factory (e.g., is a pre-programmed feature of the device), ii) downloaded locally or iii) downloaded remotely. The device can be stationary if the device meets one or more specified mobility criteria. The device can be assigned with a self-wakeup character when the device is stationary and can be provisioned with the self-wakeup character by the network. The device can wake up fully or partially to send the indication that the device has woken up, and to establish one or more appropriate communication channels or sessions if there is stored information pending to be sent to the device. The communication channels can include i) short data burst channels and ii) full communication channels or sessions.

An apparatus is provided including at least one processor and at least one memory including computer program code. The memory and computer program code are configured to, with the processor, cause the apparatus to send, by a device, a self-wakeup mode indication to a network, independently wake up the device, e.g. by the device based on the device's own algorithm. The memory and computer program code are configured to, with the processor, cause the apparatus to send, by the device, another indication to the network indicating that the device has woken up and is ready for communication. The memory and computer program code are configured to, with the processor, cause the apparatus to establish one or more communication channels between the device and the network (e.g., if there is stored information at the network waiting to send to the device). The memory and computer program code are configured to, with the processor, cause the apparatus to receive, by the device, the stored information.

Other aspects provide: an apparatus operable, configured, or otherwise adapted to perform any one or more of the aforementioned methods and/or those described elsewhere herein; a non-transitory, computer-readable media comprising instructions that, when executed by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example 5G data storage architecture.

FIG. 3 depicts a block diagram of an example wireless device.

FIG. 4 depicts a call flow of a simplified registration procedure in a wireless communications network.

FIG. 5 depicts a flowchart illustrating example operations by a network entity.

FIG. 6 depicts a flowchart illustrating example operations by a wireless device.

### DETAILED DESCRIPTION

Aspects of the present disclosure relate to wireless communications, and more particularly, to systems, devices, methods, and techniques for managing power consumption in stationary wireless devices through self-wakeup mode indications and network-coordinated communication management.

Power consumption is a significant concern for wireless devices, particularly those requiring extended battery life spanning several years or longer, such as reduced capability (RedCap) devices and Internet-of-Things (IoT) devices. Existing power-saving techniques, including relaxed measurement criteria for stationary devices and extended discontinuous reception (eDRX), still require devices to wake up according to predefined network parameters. This constraint limits the potential for further power savings in stationary devices that could otherwise remain in sleep mode for extended periods without network-initiated wake-up events. Additionally, when such devices do wake up, there is a need for efficient mechanisms to determine whether pending data exists and to establish appropriate communication channels for data exchange.

The present disclosure addresses these challenges by enabling a device to send a self-wakeup mode indication (also referred to as a no-wakeup indication) to a network, informing the network that the device should not be woken up by network-initiated communications. The network stores mobility characteristics of the device, including the self-wakeup mode indication, and refrains from waking up the device based on this indication. While the device is in sleep mode, the network stores any data, information, or messages intended for the device. The device independently wakes up based on its own algorithm and sends another indication to the network indicating that the device has woken up and is ready for communication. The network then checks for any stored data or messages pending to be sent to the device and establishes appropriate communication channels, which may include short data burst channels or full communication channels, to transmit the stored information. The device may be designated as stationary based on meeting specified mobility criteria, such as relaxed measurement criteria, or may be pre-provisioned with a stationary designation and self-wakeup character through factory configuration, local download, or remote download.

The disclosed techniques provide significant power savings for stationary wireless devices by eliminating the requirement for devices to wake up according to network-defined parameters, allowing devices to manage their own wake-up schedules based on internal algorithms optimized for their specific use cases. This approach extends battery life for devices that may operate for years without battery replacement. The network-side storage of pending data ensures that no information is lost while the device sleeps, and the establishment of appropriate communication channels upon device wake-up enables efficient data exchange tailored to the amount and type of pending information. The flexibility in designating devices as stationary through various mechanisms, including network-based determination from mobility behavior or pre-provisioning, accommodates diverse deployment scenarios and device types

### Introduction to Wireless Communications Networks

The techniques and methods described herein may be used for various wireless communications networks. While aspects may be described herein using terminology commonly associated with 4G, 5G, and/or 6G wireless technologies, aspects of the present disclosure may likewise be applicable to other communications systems and standards not explicitly mentioned herein.

A communication system may include a RAN that supports wireless communication. Communication in a RAN may be performed in accordance with one or more RATs, including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread OFDM (DFT-S-OFDM), among others.

A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others. To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

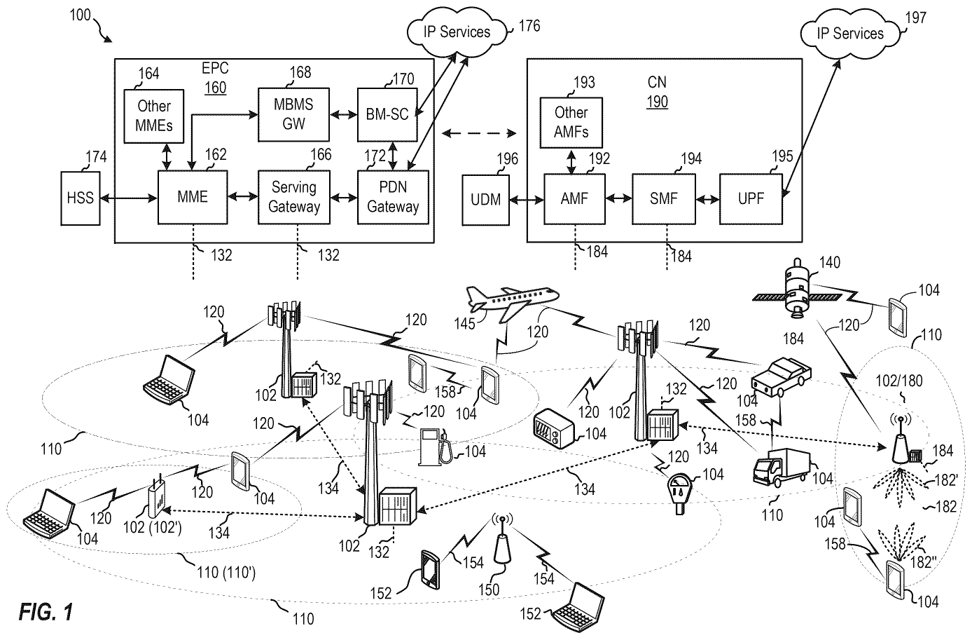

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a UE, a BS, a component of a BS, a server, etc.). For example, various functions of a network as well as various devices associated with and interacting with a network may be considered network entities. Further, wireless communications network 100 includes terrestrial aspects, such as ground-based network entities 102, and non-terrestrial aspects, such as satellite 140 and aircraft 145, which may include network entities on-board (e.g., one or more BSs) capable of communicating with other network elements (e.g., terrestrial BSs) and UEs.

In the depicted example, wireless communications network 100 includes network entities 102, UEs 104, and one or more core networks, such as an evolved packet core (EPC) 160 and core network 190 (e.g., such as a 5G Core (5GC) network or 6G core (6GC) network, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

A network entity 102 may support wireless communication in accordance with one or more coverage areas 110, and may be referred to as a network element, a network node, a RAN node, or network equipment, among other nomenclature.

Network entities 102 wirelessly communicate with (e.g., transmit signals to or receive signals from) UEs 104 via communications links 120. The communications links 120 between network entities 102 and UEs 104 may include uplink (UL) (also referred to as reverse link) transmissions from a UE 104 to a network entity 102 and/or downlink (DL) (also referred to as forward link) transmissions from a network entity 102 to a UE 104. The communications links 120 may use multiple-input and multiple-output (MIMO) antenna technology, including spatial multiplexing, beamforming, and/or transmit diversity in various aspects. MIMO communication generally refers to transmitting or receiving multiple signals (such as multiple layers or multiple data streams) simultaneously over the same time and frequency resources. To implement beamforming, the amplitudes or phases of signals transmitted via antenna elements may be modulated and shifted relative to each other (such as by manipulating a phase shift, a phase offset, or an amplitude) to generate one or more beams. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, the wireless communication network 100 may implement multi-TRP (mTRP) operation (including redundant transmission or reception on multiple TRPs) or non-coherent joint transmission (NC-JT).

The network entity 102 and the UE 104 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network entity 102 transmitting signals (for example, SSBs or other signals) via respective beams and the UE 104 receiving and measuring the signal(s) via respective beams of multiple beams to identify a best beam (or beam pair) for communication between the UE 104 and the network entity 102. A beam refinement operation may involve a first device (for example, the UE 104 or the network entity 102) transmitting signal(s) via a subset of beams (for example, identified based on, or otherwise associated with, measurements reported as part of one or more other beam management operations). A second device (for example, the network entity 102 or the UE 104) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

One or more of the network entities 102 may include or may be referred to as a BS. Depending on its capabilities, a BS may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, an access point, a base transceiver station, radio BS, radio transceiver, transceiver function, a transmission reception point, or other suitable terminology.

Each of network entities 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells. The wireless communication network 100 may include a heterogeneous network in which different types of network entities 105 support communication for one or more coverage areas 110 using the same or different RATs.

In some examples, a network entity 102 may be implemented in an aggregated (such as monolithic, standalone) architecture, which may utilize a protocol stack that is physically or logically integrated within one network entity 105 (such as a single physical RAN node). While network entities 102 are depicted in various aspects as unitary communications devices, network entities 102 may be implemented in various configurations. More generally, a BS (e.g., network entity 102) may include components that are located at a single physical location or components located at various physical locations. In examples in which a BS includes components that are located at various physical locations, the various components may each perform functions such that, collectively, the various components achieve functionality that is similar to a BS that is located at a single physical location. For example, one or more components of a BS may be disaggregated, which may utilize a protocol stack that is physically or logically distributed among multiple network entities 105, including in an integrated access and backhaul (IAB) network, an open RAN (O-RAN), or a virtualized RAN (vRAN). A disaggregated BS may include a central unit (CU), one or more distributed units (DUs), one or more radio units (RUs), a Near-Real Time (Near-RT) RAN Intelligent Controller (RIC), or a Non-Real Time (Non-RT) RIC, to name a few examples. A BS may be a disaggregated BS. In another example, various aspects of a BS may be virtualized. The wireless communication system may implement a service-based architecture that provides a modular framework in which control plane functionality and common data repositories may be delivered through a set of interconnected network functions (NFs) that may access services of other NFs.

Different network entities 102 within wireless communications network 100 may also be configured to support different RATs, such as 4G, 5G, and/or 6G. For example, network entities 102 configured for 4G LTE (collectively referred to as Evolved Universal Mobile Telecommunications System (UMTS) Terrestrial RAN (E-UTRAN)) may interface with the EPC 160 through first backhaul links 132 (e.g., an S1 interface). Network entities 102 may interface with core network 190 through second backhaul links 184. Network entities 102 may communicate directly or indirectly (e.g., through the EPC 160 or core network 190) with each other over third backhaul links 134 (e.g., X2 interface), which may be wired or wireless.

Wireless communications network 100 may subdivide the electromagnetic spectrum into various classes, licensed or unlicensed operating bands, frequency ranges, component carriers, or channels, which define associated frequencies available for communications. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7.125 GHz, which is often referred to (interchangeably) as “Sub-6 GHz”; FR3 as including frequency resources between 7.125 GHz and 24.25 GHz; and F2 as including 24.25 GHz-71.00 GHz, which is sometimes referred to (interchangeably) as a “millimeter wave” (“mmW” or “mmWave”). In some cases, FR2 may be further defined in terms of sub-ranges, such as a first sub-range FR2-1 including 24.25 GHz-52.60 GHz and a second sub-range FR2-2 including 52.60 GHz-71.00 GHz (also referred to as FR4). Communications above the upper frequency band (such as between mmW and THz frequencies, between 100 GHz and 1 THz) may be referred to as sub-Terahertz (sub-THz) communication, for example, including FR5 (114.25 GHz through 300 GHz).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 104 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network entity 102 transmitting downlink control information (DCI) to the one or more UEs 104) or reconfigured (for example, in real-time or near-real-time) according to changing network conditions in the wireless communications network 100 or specific requirements of one or more UEs 104. An active BWP defines the operating bandwidth of the UE 104 within the operating bandwidth of the serving cell.

A BS configured to communicate using mmWave/near mmWave radio frequency bands (e.g., a mmWave BS such as BS 180) may utilize beamforming (e.g., 182) with a UE (e.g., 104) to improve path loss and range.

The communications links 120 between network entities 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain BS s (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a mobility management entity (MME) 162, other MMEs 164, a serving gateway 166, a multimedia broadcast multicast service (MBMS) gateway 168, a broadcast multicast service center (BM-SC) 170, and/or a packet data network (PDN) gateway 172, such as in the depicted example. MME 162 may be in communication with a home subscriber server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN gateway 172. PDN gateway 172 provides UE IP address allocation as well as other functions. PDN gateway 172 and the BM-SC 170 are connected to IP Services 176, which may include, for example, the Internet, an intranet, an IP multimedia subsystem (IMS), a packet switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS bearer services within a public land mobile network (PLMN), and/or may be used to schedule MBMS transmissions. MBMS gateway 168 may be used to distribute MBMS traffic to the network entities 102 belonging to a multicast broadcast single frequency network (MBSFN) area broadcasting a particular service, and/or may be responsible for session management (start/stop) and for collecting eMBMS related charging information.

Core network 190 may include various functional components, including: an access and mobility management function (AMF) 192, other AMFs 193, a session management function (SMF) 194, and a user plane function (UPF) 195. AMF 192 may be in communication with unified data management (UDM) 196.

AMF 192 is a control node that processes signaling between UEs 104 and core network 190. AMF 192 provides, for example, quality of service (QoS) flow and session management.

IP packets are transferred through UPF 195, which is connected to the IP services 197, and which provides UE IP address allocation as well as other functions for core network 190. IP Services 197 may include, for example, the Internet, an intranet, an IMS, a PS streaming service, and/or other IP services.

In various aspects, a network entity or network node can be implemented as an aggregated BS, as a disaggregated BS, a component of a BS, an integrated access and backhaul (IAB) node, a relay node, a sidelink node, to name a few examples. Wireless backhaul, midhaul, or fronthaul may be implemented via one or more IAB nodes, which may act as a relay using resources of an IAB donor network entity 102. The wireless communication network 100 may include one or more of a relay that may steer or reflect signals transmitted by other entities, which may support any of the described communication links. A relay may include active elements or passive elements, and may be in the form of a reconfigurable intelligent surface (RIS). A RIS may include tunable reflecting antenna arrays or metasurfaces, which may be used to enhance coverage or efficiency in multipath environments.

Some aspects and techniques as described herein may be implemented, at least in part, using an AI/ML model, such as a program that includes a machine learning (ML) model or an artificial neural network (ANN) model. The AI/ML model may be deployed at one or more devices (for example, one or more network entities 102, one or more UEs 104, one or more servers, or one or more components of a cloud computing network, among other examples). For example, in a deployment in which AI/ML functionality is performed independently at a device, sometimes referred to as “overlay AI/ML,” Additionally, or alternatively, in a deployment where AI/ML functionality is coordinated between different devices, sometimes referred to as “coordinated AI/ML,” or performed at all device and network layers, sometimes referred to as “native AI/ML,” the AI/ML model (or an instance of the AI/ML model) may be deployed at multiple devices (for example, a first portion of the AI/MBL model may be deployed at a UE 104 and a second portion of the AI/ML model may be deployed at a network entity 102). In other examples of coordinated AI/MBL or native AI/ML, a first AI/ML model may be deployed at a UE 104 and a second AI/ML model may be deployed at a network entity 102. The AI/ML model(s) may be configured to enhance various aspects of the wireless communications network 100 (for example, to increase privacy, reliability, or efficient use of network bandwidth, or to reduce latency, among other examples). For example, the AI/ML model(s) may be trained to identify patterns or relationships in data corresponding to the wireless communications network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 104, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/MBL procedures (for example, RAN-triggered service establishment, configuration, inferencing using UE-side or network-side models, performance monitoring or management, or capability signaling, among other examples). Additionally, or alternatively, the AI/MVL model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples).

A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network entity 102 to a UE 104. DCI generally contains the information the UE 104 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples.

Wireless communications systems may utilize OFDM with a cyclic prefix (CP) on the uplink and downlink. Such systems may also support half-duplex operation using time division duplexing (TDD). OFDM and SC-FDM partition the system bandwidth into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD) or in a sub-band full duplex (SBFD) configuration, in which, for a particular set of subcarriers, subframes within the set of subcarriers are dedicated for both DL and UL.

In certain aspects, the number of slots within a subframe is based on a slot configuration and a numerology. For example, for slot configuration 0, different numerologies (μ) 0 to 6 allow for 1, 2, 4, 8, 16, 32, and 64 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where is the numerology 0 to 6. As such, the numerology μ=0 has a subcarrier spacing of 15 kHz and the numerology μ=6 has a subcarrier spacing of 960 kHz. The symbol length/duration is inversely related to the subcarrier spacing.

A resource grid may be used to represent the frame structure. Each time slot includes a RB (also referred to as physical RBs (PRBs)) that extends, for example, 12 consecutive subcarriers. The resource grid is divided into multiple resource elements (REs). The number of bits carried by each RE depends on the modulation scheme. Some of the REs carry reference (pilot) signals (RS) for a UE (e.g., UE 104 of FIG. 1). The RS may include DMRS and/or CSI-RS for channel estimation at the UE. The RS may also include beam measurement RS (BRS), beam refinement RS (BRRS), and/or PT-RS.

The PDCCH carries DCI within one or more control channel elements (CCEs), each CCE including, for example, nine RE groups (REGs), each REG including, for example, four consecutive REs in an OFDM symbol.

A PSS may be within symbol 2 of particular subframes of a frame. The PSS is used by a UE (e.g., 104 of FIG. 1) to determine subframe/symbol timing and a physical layer identity.

A SSS may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The PBCH, which carries a master information block (MIB), may be logically grouped with the PSS and SSS to form a synchronization signal (SS)/PBCH block. The MIB provides a number of RBs in the system bandwidth and a system frame number (SFN). The PDSCH carries user data, broadcast system information not transmitted through the PBCH such as system information blocks (SIBs), and/or paging messages. For example, a PDSCH can carry a MAC control element (MAC-CE), an RRC message, or user data, among other examples. Each PDSCH may carry one or more transport blocks (TBs) of data.

Some of the REs carry DMRS (indicated as R for one particular configuration, but other DMRS configurations are possible) for channel estimation at the BS. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit SRS. The SRS may be transmitted, for example, in the last symbol of a subframe. The SRS may have a comb structure, and a UE may transmit SRS on one of the combs. The SRS may be used by a BS for channel quality estimation to enable frequency-dependent scheduling on the UL.

The PUCCH may be located as indicated in one configuration. The PUCCH carries uplink control information (UCI), such as scheduling requests, CSI, and HARQ ACK/NACK feedback. CSI can include a channel quality indicator (CQI) (indicative of downlink channel conditions to facilitate selection of transmission parameters, such as an MCS, by a network entity 102), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. The PUSCH carries data, and may additionally be used to carry a buffer status report (BSR), a power headroom report (PHR), and/or UCI. Each PUSCH may carry one or more TBs of data.

The information (for example, data, control information, or reference signal information) transmitted by a network entity 102 to a UE 104, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network entity 102 or a UE 104 over a wireless communication channel. In some examples, the network entity 102 or the UE 104 may select an MCS (for example, an order of quadrature amplitude modulation (QAM), such as 64-QAM, 128-QAM, or 256-QAM, among other examples) for a downlink signal or an uplink signal. For example, the network entity 102 may select an MCS for a downlink signal in accordance with UCI received from the UE 104 or may transmit, to the UE 104, an indication of an MCS to be applied for an uplink signal.

### Example 5G Storage Architecture

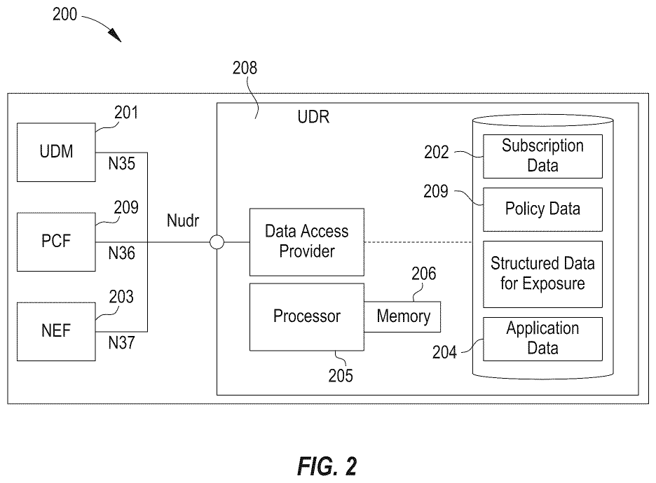

FIG. 2 depicts an example 5G cellular system and data storage architecture 200. The 5G data system architecture 200 may allow a unified data management (UDM) 201, a network exposure function (NEF) 203, a policy control function (PCF) 209, and other functions to store data in a unified data repository (UDR) 208.

The UDR 208 may store user data, customer profile information, subscription data 202, policy data 210, structure data for exposure, and application data 204. The UDR 208 may include a processor 205 for processing data and a memory 206 for storing data.

The UDM 201 may communicate with the UDR 208 via an N35 interface and a Nudr interface through a data access provider. The UDM 201 may manage network user data in a single, centralized element. In some cases, the UDM 201 may be similar to a 4G network's home subscriber service (HSS) but may be cloud-native and designed for 5G. The UDM 201 may be paired with the UDR 208, for example, to store user data such as customer profile information.

The NEF 203 may communicate with the UDR 208 via an N37 interface and the Nudr interface through the data access provider. The NEF 203 may be located between the 5G core network and third-party applications used by the 5G network. The NEF 203 may be responsible for offering and managing connections from external applications that access internal data of the 5G core network. Data access to internal 5G core network data may be via the data access provider for third-party applications.

The PCF 209 may communicate with the UDR 208 via an N36 interface and the Nudr interface through the data access provider. The policy data 210 may be used by the PCF 209 to authenticate users as one of many functions.

The UDM 201, PCF 209, and NEF 203 may each contain processors and memories.

Wireless device subscription data 202, policy data 210, application data 204, structured data, and other data may be stored in any one of the UDM 201, the NEF 203, the PCF 209, or the UDR 208, as well as other entities in the 5G system.

### Example Wireless Device

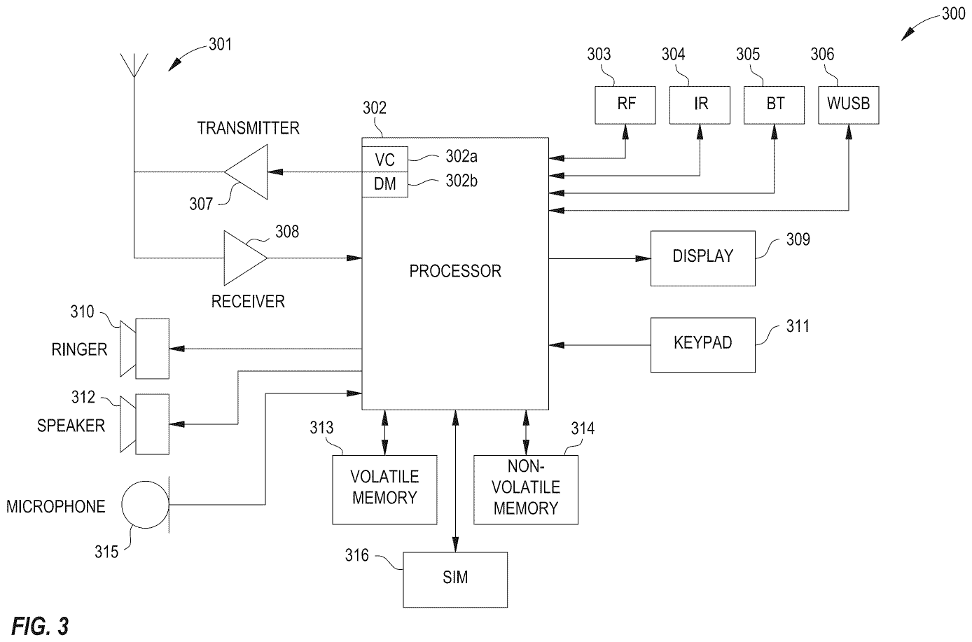

FIG. 3 is a block diagram of a wireless device 300 (such as a UE 104 illustrated in FIG. 1).

As shown in FIG. 3, the wireless device 300 may include an antenna 301 in communication with a transceiver, such as with a transmitter 307 which enables wireless transmission of data and a receiver 308 which enables wireless reception of data. In some cases, the transmitter 307 and the receiver 308 may be separate components. The transmitter 307 and the receiver 308 may include or be coupled with modulators and demodulators, and other aspects.

In order to receive downlink transmission, the wireless device 300 may include antennas that may receive the downlink signals from a network entity (e.g., such as a network entity 102 of FIG. 1) and may provide received signals to demodulators (DEMODs) in the receiver 308. Each demodulator may condition (e.g., filter, amplify, downconvert, and digitize) a respective received signal to obtain input samples. Each demodulator may further process the input samples to obtain received symbols. A MIMO detector in receiver 308 may obtain received symbols from all the demodulators, perform MIMO detection on the received symbols if applicable, and provide detected symbols. A receive processor may process (e.g., demodulate, deinterleave, and decode) the detected symbols, provide decoded data to a data sink, and provide decoded control information to a controller/processor, such as processor 302.

Control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples. Downlink reference symbols may be for the primary synchronization signal (PSS), secondary synchronization signal (SSS), PBCH demodulation reference signal (DMRS), channel state information reference signal (CSI-RS), phase tracking reference signal (PTRS), or tracking reference signal (TRS).

In to transmit uplink transmission, the wireless device 300 may further include a transmit processor that may receive and process data (e.g., for the physical uplink shared channel (PUSCH)) from a data source and control information (e.g., for the physical uplink control channel (PUCCH)) from the controller/processor. The transmit processor may also generate reference symbols for a reference signal (e.g., for the sounding reference signal (SRS)). The symbols from the transmit processor may be precoded by a TX MIMO processor if applicable, further processed by the modulators in the transmitter 307, and transmitted to network entity.

In some examples, the wireless device 300 may perform a channel coding operation or a FEC operation to control errors in transmitted information. For example, the wireless device 300 may perform an encoding operation to generate encoded information (such as by selectively introducing redundancy into the information, typically using an error correction code (ECC), such as a polar code or a low-density parity-check (LDPC) code).

The wireless device 300 may further perform spatial processing (for example, precoding) on the encoded information to generate one or more processed or precoded signals for downlink or uplink transmission, respectively. In some examples, the wireless device 300 may perform codebook-based precoding or non-codebook-based precoding. Codebook-based precoding may involve selecting a precoder (for example, a precoding matrix) using a codebook. Non-codebook-based precoding may involve selecting or deriving a precoder based on, or otherwise associated with, one or more downlink or uplink signal measurements.

The wireless device 300 may also include a processor 302 configured to provide signals to and receive signals from the transmitter 307 and the receiver 308, respectively, and to control the functioning of the wireless device 300. The processor 302 may be configured to control the functioning of the transmitter 307 and the receiver 308 by effecting control signaling via electrical leads to the transmitter 307 and the receiver 308. The processor 302 may be configured to control other elements of the wireless device 300 by effecting control signaling via electrical leads connecting the processor 302 to the other elements, such as a display 309 or a memory 313 or 314.

The processor 302 may be embodied via one or more electrical and computational components including circuitry, at least one processing core, one or more microprocessors with accompanying digital signal processor(s) (DSP(s)), one or more processor(s) without an accompanying digital signal processor, one or more coprocessors, one or more multi-core processors, one or more controllers, processing circuitry, one or more computers, various other processing elements including one or more chips, one or more system on chips (SoCs), one or more chipsets, one or more packages, one or more integrated circuits (ICs) such as an application specific integrated circuit (ASIC) or field programmable gate array (FPGA), or some combination thereof that constitute the processor 302.

The processor 302 may interface with other components of the wireless device 300 and may generally process information (such as inputs or signals) received from such other components and output information (such as outputs or signals) to such other components. In various aspects, the processor 302 may be representative of one or more of a receive processor, a transmit processor, a TX MIMO processor, and/or a controller/processor. The processor 302 may include a voice coder (VC) 302a and a data modem (DM) 302b.

A processor including exactly one processing core may be referred to as a single-core processor, while a processor including more than one processing core may be referred to as a multi-core processor. Accordingly, although illustrated in FIG. 3 as a single processor, in some cases the processor 302 may include a plurality of processors or processing cores.

The wireless device 300 may be capable of operating with one or more air interface standards, communication protocols, modulation types, access types, and/or the like. The wireless device 300 may be capable of operating in accordance with various first generation (1G) protocols. The wireless device 300 may also be capable of operating in accordance with Internet Protocol Multimedia Subsystem (IMS) communication protocols, such as session initiation protocol (SIP). In some cases, the wireless device 300 may be capable of operating in accordance with 2G wireless communication protocols including IS-136, Time Division Multiple Access (TDMA), Global System for Mobile communications (GSM), IS-95, and Code Division Multiple Access (CDMA). The wireless device 300 may be capable of operating in accordance with 2.5G wireless communication protocols including General Packet Radio Service (GPRS) and Enhanced Data GSM Environment (EDGE). The wireless device 300 may be capable of operating in accordance with 3G wireless communication protocols such as Universal Mobile Telecommunications System (UMTS), Code Division Multiple Access 2000 (CDMA2000), Wideband Code Division Multiple Access (WCDMA), and Time Division-Synchronous Code Division Multiple Access (TD-SCDMA). The wireless device 300 may additionally be capable of operating in accordance with 3.9G wireless communication protocols such as Long Term Evolution (LTE) or Evolved Universal Terrestrial Radio Access Network (E-UTRAN). The wireless device 300 may be capable of operating in accordance with 4G wireless communication protocols such as LTE Advanced and similar wireless communication protocols. The wireless device 300 may also be capable of operating according 5G protocols. The wireless device 300 may also be capable of operating according to 6G protocols or beyond. The wireless device 300 may also be capable of operating according to Wi-Fi or Worldwide Interoperability for Microwave Access (WiMAX) protocols.

The wireless device 300 may include components for sharing and/or obtaining data. The wireless device 300 may include a short-range radio frequency (RF) transceiver 303 so data may be shared with and/or obtained from electronic devices in accordance with RF techniques. The wireless device 300 may include other short-range transceivers, such as an infrared (IR) transceiver 304, a Bluetooth transceiver 305 operating using Bluetooth brand wireless technology developed by the Bluetooth Special Interest Group, and a wireless universal serial bus (USB) transceiver 306. The Bluetooth transceiver 305 may be capable of operating according to low power or ultra-low power Bluetooth technology, such as Bluetooth low energy radio standards.

The wireless device 300, and in particular the short-range transceivers, may be capable of transmitting data to and/or receiving data from electronic devices within a proximity of the wireless device 300, such as within 10 meters. Although not shown, the wireless device 300 may be capable of transmitting and/or receiving data from electronic devices according to various wireless networking techniques, including 6LoWpan, Wi-Fi, Wi-Fi low power, wireless local access network (WLAN) techniques such as Institute of Electrical and Electronics Engineers (IEEE) 802.11 techniques, IEEE 802.15 techniques, and IEEE 802.16 techniques.

The wireless device 300 may include computer-readable medium/memory that may be implemented in the form of one or more memory devices, memory components, memory blocks, memory elements or other discrete gate or transistor logic or circuitry. The computer-readable medium/memory may include a subscriber identity module (SIM) 316, a removable user identity module (R-UIM), and/or the like, which may store information elements related to a mobile subscriber. In addition to the SIM 316, the wireless device 300 may include other removable and/or fixed memory. The computer-readable medium/memory may include a volatile memory 313 and/or tangible storage media including a non-volatile memory 314. At least part of the volatile memory 313 and/or the non-volatile memory 314 may be embedded in the processor 302.

The volatile memory 313 may include Random Access Memory (RAM) including dynamic RAM (DRAM), static RAM (SRAM), synchronous DRAM (SDRAM) such as low power double data rate (LPDDR) memory, on-chip cache memory, off-chip cache memory, and/or the like.

The non-volatile memory 314, which may be embedded and/or removable, may include read-only memory (ROM), flash memory, a solid state drive (SSD), a hard disk drive (HDD), magnetic storage devices (for example, hard disks, floppy disk drives, magnetic tape, etc.), optical disc drives and/or media, non-volatile random-access memory (NVRAM), and/or the like. Like the volatile memory 313, the non-volatile memory 314 may include a cache area for temporary storage of data.

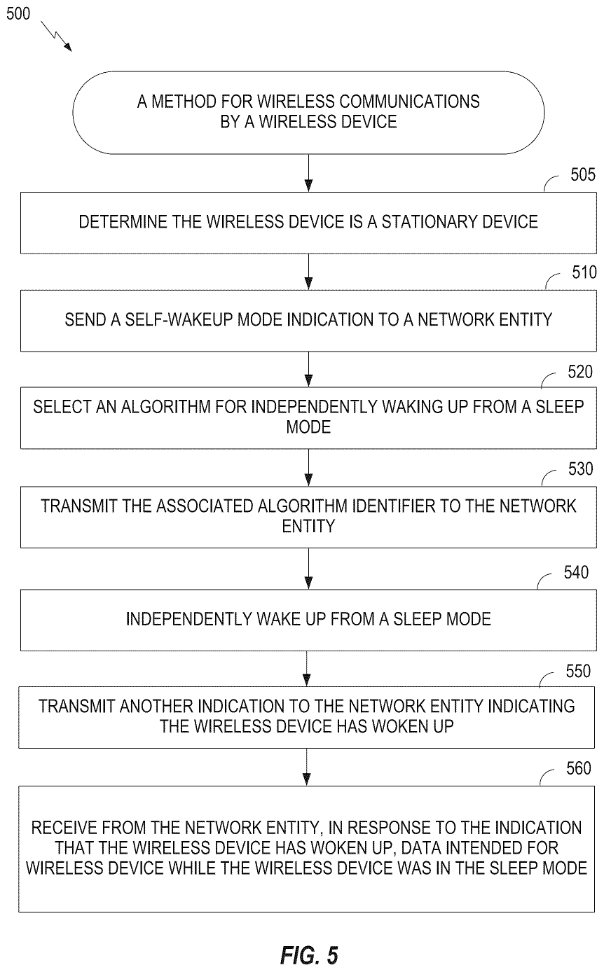

The volatile memory 313 and the non-volatile memory 314 may store one or more software programs, instructions, pieces of information, data, and/or the like which may be used by the wireless device 300 for performing functions of the wireless device 300. For example, the volatile memory 313 and the non-volatile memory 314 may include an identifier, such as an international mobile equipment identification (IMEI) code, capable of uniquely identifying the wireless device 300. The volatile memory 313 and the non-volatile memory 314 may be non-transitory computer-readable medium/memory configured to store computer executable code (e.g., executable instructions), including code for determining the wireless device is a stationary device, code for sending a self-wakeup mode indication to a network entity, code for selecting an algorithm for independently waking up from a sleep mode, code for transmitting the associated algorithm identifier to the network entity, code for independently waking up from the sleep mode, code for transmitting another indication to the network entity indicating that the wireless device has woken up, and/or code for receiving, from the network entity, in response to the indication that the wireless device has woken up, data intended for the wireless device while the wireless device was in the sleep mode. Processing of the code may cause the wireless device to perform the method 500 described with respect to FIG. 5, or any aspect related to it.

The wireless device 300 may also include a user interface including, for example, an earphone or a speaker 312, a ringer 310, a microphone 315, a display 309, a user input interface, and/or the like, which may be operationally coupled to the processor 302. The user input interface may include devices allowing the wireless device 300 to receive data, such as a keypad 311, a touch display, a joystick, and/or at least one other input device. In some cases, the keypad 311 may include numeric 0-9 and related keys, and/or other keys for operating the wireless device 300.

The processor 302 may include user interface circuitry configured to control at least some functions of one or more elements of the user interface, such as the speaker 312, the ringer 310, the microphone 315, the display 309, and/or the like. The processor 302 and/or user interface circuitry including the processor 302 may be configured to control one or more functions of one or more elements of the user interface through computer program instructions, for example, software and/or firmware, stored on a memory accessible to the processor 302, for example, the volatile memory 313, the non-volatile memory 314, and/or the like.

The wireless device 300 may also include a stereo microphone and at least one camera.

The wireless device 300 may include a battery for powering various circuits related to the mobile terminal, for example, a circuit to provide mechanical vibration as a detectable output.

The processor 302 may include functionality to operate one or more software programs, which may be stored in the volatile memory 313 or the non-volatile memory 314. The processor 302 and stored software instructions associated therewith may be configured to cause the wireless device 300 to perform actions. For example, the processor 302 may be capable of operating a connectivity program, such as a web browser. The connectivity program may allow the wireless device 300 to transmit and receive web content, such as location-based content, according to a protocol, such as wireless application protocol (WAP), hypertext transfer protocol (HTTP), and/or the like. The processor 302 may be configured to perform physical (PHY) layer operations and medium access control (MAC) layer operations, and, in some instances, upper layer operations, associated with transmitting and receiving wireless communications.

In some examples, the wireless device 300 may also include at least one other external network interface (not shown) that enables the processor 302 to communicate with another network (such as a core network, a backhaul network) to gain access to external networks including the Internet.

The processor 302 may be coupled to the computer-readable medium/memory via a bus. The processor 302 may include circuitry configured to implement (e.g., execute) the code stored in the computer-readable medium/memory, including circuitry for determining the wireless device is a stationary device, circuitry for sending a self-wakeup mode indication to a network entity, circuitry for selecting an algorithm for independently waking up from a sleep mode, circuitry for transmitting the associated algorithm identifier to the network entity, circuitry for independently waking up from the sleep mode, circuitry for transmitting another indication to the network entity indicating that the wireless device has woken up, and/or circuitry for receiving, from the network entity, in response to the indication that the wireless device has woken up, data intended for the wireless device while the wireless device was in the sleep mode. Processing with the circuitry may cause the wireless device 300 to perform the method 500 described with respect to FIG. 5, or any aspect related to it.

The wireless device 300 may further include any additional circuitry or components for the processor 302 to operate to perform the functions and processes described herein. In some examples, the processor 302 may further include, be coupled with, or be connected to one or more encoding circuits and decoding circuits (also referred to herein simply as “encoders” and “decoders,” respectively), one or more segment parsing circuits and deparsing circuits (also referred to herein simply as “segment parsers” and “segment deparsers,” respectively), one or more stream parsing circuits and deparsing circuits (also referred to herein simply as “stream parsers” and “stream deparsers,” respectively), and modulation circuits and demodulation circuits or circuitry (not specifically shown). For example, the processor 302 can include one or more modulation circuits and demodulation circuits in the form of one or more modem chips (also referred to herein simply as “modems”), each including processor circuitry configured for performing modulation or demodulation of wireless communication signals, among other functions associated with PHY layer operations.

In some examples, the modem circuitry, whether implemented internal or external to the processor 302, may further include, be coupled with, or be connected to one or more radio frequency (RF) and analog circuits or circuitry (not specifically shown). In some examples in which the processor 302 includes modem circuitry, the processor 302 may include at least some of the RF and analog circuitry. In some other examples, most or all of the RF and analog circuitry is separate from but coupled directly or indirectly with or connected to the processor 302, such as to the modem circuitry. The RF and analog circuitry can include RF chains or transceiver circuitry (or transceivers), which may include one or more filters, mixers, oscillators, amplifiers such as power amplifiers (PAs) or low-noise amplifiers (LNAs), analog-to-digital converters (ADCs), digital-to-analog converters (DACs), power trackers, or other components that process signals including converting them between analog (such as for transmission or reception via an air interface) and digital (such as for processing by the processor 302) domains.

### Example Call Flow for Self-Wakeup

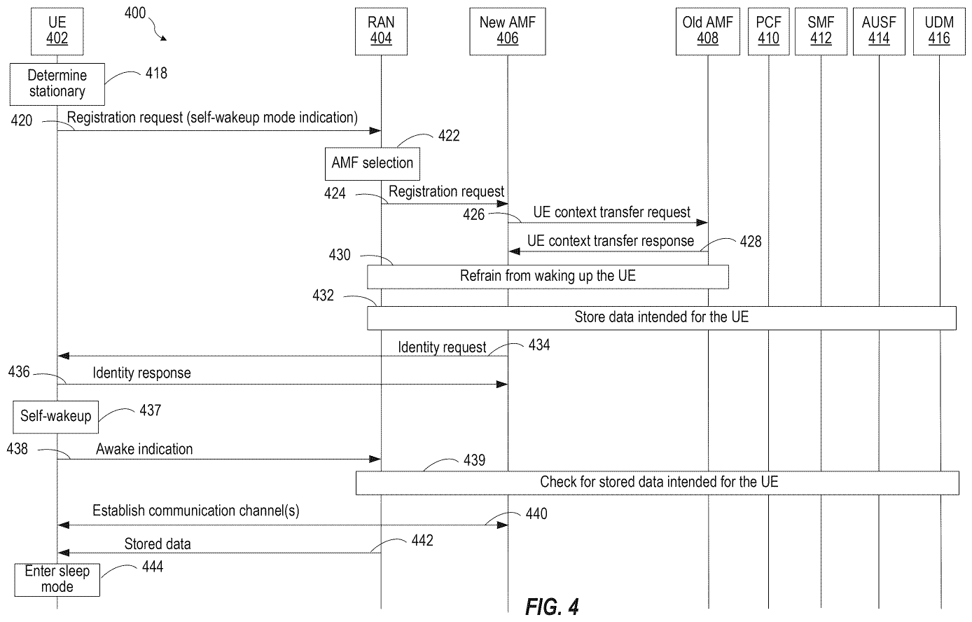

FIG. 4 depicts a call flow illustrating example operations 400 for communications in a network.

As shown, the operations 400 may include, at operation 418, a UE 402 determining it is a stationary wireless device. In some aspects, the UE 402 is an example of a UE 104 of FIG. 1 and/or the wireless device 300 of FIG. 3. In some aspects, the UE 402 is configured or pre-configured by the RAN 404 as a stationary device. In some aspects, the RAN 404 may be a base station, such as a BS 102 of FIG. 1. In some aspects, the RAN 404 configures the UE 402 with one or more mobility criteria associated with being a stationary device. In some aspects, the UE 402 may have stationary information factory built-in, such pre-programmed features of the UE 402.

In some aspects, the RAN 404 categorizes the UE 402 as a stationary device based on a measurement associated with the UE 402. In some aspects, the RAN 404 restricts the mobility of the UE 402 to be stationary. In some aspects, the RAN 404 categorizes or restricts the mobility of the UE 402 as stationary based on the UE 402 meeting a stationary criteria to relax a measurement report requirement of the UE 402. In some aspects, the UE 402 may determine, at operation 418, that it is stationary based on the categorization or restriction by the RAN 404.

The UE 402 may be designated as stationary wireless device if the UE 402 meets the relaxed measurement criterion. In some aspects, after registration, a UE can start establishing a communication session with the network. In some cases, the UE can camp idlily in an area covered by one or more base stations. The BSs and/or other entities in the cellular system can track the UE movements and know where the UE is located (e.g., a latest location). The UE can perform measurements of downlink signals and/or of the UE's positions and report the measurements back to the BS periodically. The BS can relax the measurement report requirements (e.g., if the UE is considered stationary). In some aspects, the BS relaxes the UE's measurement report requirements if the stationary UE meets the following criteria (e.g., as defined in TS 38.331):

### SS-RSRPRefStationaryConnected-SS-RSRP<SSearchDeltaP-StationaryConnected,

SS-RSRP is the current layer 3 (L3) reference signal received power (RSRP) measurement (in dB) of the Pcell based on a synchronization signal block (SSB) measurement and SS-RSRPRefStationaryConnected is a reference SS-RSRP value of the Pcell. The reference SS-RSRP value may be set at the end of the RRC reconfiguration procedure (e.g., as specified in TS 38.331, Section 5.3.5.3), when a rrm-MeasRelaxationReportingConfig is included in the RRCReconfiguration message; or after MAC successfully completes a random access procedure after applying a reconfigurationWithSync in spCellConfig while stationary criterion is configured; or if SS-RSRP-SS-RSRPRefStationaryConnected>0; or if the relaxed measurement criterion has not been met for TsearchDeltaP-StationaryConnected, the UE shall set the value of SS-RSRPRefStationaryConnected to the current SS-RSRP value of the serving cell. The relaxed measurement can provide certain devices/equipments, such as reduced capability (RedCap) and Internet-of-Things (IoT) devices, more flexibility with less frequent measurement reports and can save power for the UE 402.

In some aspects, the RAN 404 may designate or register the UE 402 as a stationary device based on “Expected UE behaviour parameters” where the parameters include “Expected UE Moving Trajectory” that identifies the UE's expected geographical movement (e.g., a planned path of movement) and a “Stationary Indication” that identifies whether the UE is station or mobile. In some aspects, the “Expected UE behaviour parameters” includes a “No wakeup Indication” parameter which may be set of 1 or 0, where 1 indicates no wakeup and 0 is a default value.

In some aspects, the RAN 404 may designate or register the UE 402 as a stationary device based on communication parameters including “Periodic communication indicator” that identifies whether the UE communicates periodically or not (e.g., only on demand); “Communication duration time” that indicates a duration interval time of periodic communication together with the “Periodic communication indictor”; “Periodic time” indicating an interval time of periodic communication together with the “Periodic communication indicator”; “Scheduled communication time” indicating a time zone and day of the week when the UE is available for communication; and/or “Stationary indication” identifying whether the UE is stationary or mobile. In some aspects, the communication parameters include a “No Wakeup indication” that may be set to a 1 or 0, only when the parameter is present and indicated “1” then no wakeup is indicated; otherwise, the device is indicated as a default normal device. The communication parameters may include a “Battery indication” parameter that identifies power consumption criticality for the UE, for example, whether the UE is battery powered with a not-rechargeable/not-replaceable battery, or the UE is battery powered with rechargeable/replaceable battery, or is not battery powered.

Based on any of these indications, network entities, can categorize or designate the UE 402 as a stationary device. In some aspects, if the UE 402 is designated/categorized by a network entity as a stationary device, the network entity can further assign the device a self-wake character/status and inform or provision the UE 402 for self-wakeup.

At operation 420, the UE 402 sends a registration request message to the RAN 404. The registration request message may contain UE radio capability information or a capability ID and may include other UE information. The UE radio capability information may inform the RAN 404 what type of device the UE 402 is and/or the capabilities of the UE 402. In some aspects, the RAN 404 may allocate resources for the UE 402 based on the UE radio capability information.

According to certain aspects, the UE 402 includes a self-wakeup mode indication in the registration request message. The self-wakeup mode indication may indicate that the UE 402 seeks not to be woken up, regardless of whether the network has a paging message, data, or request of communication to send to the UE 402. The UE 402 may continue to sleep and may not wake up to listen to the network, and may only independently determine when to wake up based on the UE's own algorithm, and then establishes communication channels to receive any pending data before returning to a sleep mode. In some aspects, the self-wakeup mode indication indicates no wakeup.

In some aspects, the UE 402 include a bit in the registration request message indicating whether the UE 402 is in a self-wakeup mode. In some aspects, the bit is an optional field in the registration request message with a default value of “no self-wakeup” when the optional field is not included in the registration request message. When the UE 402 does not indicate self-wakeup mode, the UE 402 may be treated as a normal device and may wake up periodically according to network or system parameters broadcast by base stations in the cellular network. If the optional field is present and the self-wakeup mode is indicated, then UE 402 remains in sleep mode until the UE 402 wakes up independently by the UE's own algorithm.

In one example, the UE 402 indicates the self-wakeup mode indication in the registration request message as follows:

UE to (R)AN: Registration Request Message:
AN message (
AN parameters,
Registration Request (
Registration type,
. . .
[UE Radio Capability Update],
. . .
[UE Radio Capability ID],
. . .
)
)

A parameter can be added to the “UE Radio Capability Update” or the “UE Radio Capability ID” for the self-wakeup mode indication. For example:

UE Radio Capability Update
( . . .
no-wakeup = 1 or 0
. . .
)

In some aspects, the UE 402 sends the self-wakeup mode indication in a radio resource control (RRC) configuration message or other radio message to the RAN 404.

In some aspects, the UE 402 sends the self-wakeup mode indication based on the determination that the UE 402 is a stationary device.

In some aspects, the UE 402 is configured to send self-wakeup mode indication. For example, the UE 402 may be built-in in a factory, download locally, download remotely, or be configured by the RAN 404 for the self-wakeup mode and to send the self-wakeup mode indication.

In some aspects (now shown), the UE 402 further selects a self-wakeup algorithm from multiple potential self-wakeup algorithms at the UE 402. In some aspects, each of multiple potential self-wakeup algorithms may be assigned with a respective algorithm ID. The algorithm is not an eDRX configuration.

In some aspects (not shown), the UE 402 may inform the RAN 404 of the selected self-wakeup algorithm. In some aspects, the UE 402 sends the associated algorithm ID of the selected self-wakeup algorithm to the RAN 404. In some aspects, the UE 402 may include the algorithm ID in the registration request message as an optional field in additional to the self-wakeup mode indication field. In some aspects, the UE 402 sends a single field indicating the algorithm ID, which indicates the self-wakeup mode, or the UE 402 does not include the algorithm ID or includes a default algorithm ID, which indicates no self-wakeup mode. In some aspects, the self-wakeup algorithms are defined in a wireless standard. By informing the network of the selected algorithm, the network may be aware of when and how the device will wake up, enabling the network to anticipate device wake-up events.

In some aspects (not shown), the RAN 404 stores the self-wakeup mode information.

At operation 422, the RAN 404 may select the access mobility management function (AMF) entity 406 for handling registration.

At operation 424, the RAN 404 may forward the self-wakeup mode information to the AMF 406, for example, in the registration request message.

In some aspects (not shown), the AMF 406 may store the self-wakeup mode information locally. In some aspects (not shown), the AMF 406 may forward the self-wakeup mode information to one other entities, such as the PCF 410, the SMF 412, the authentication server function (AUSF) 414, and/or the UDM 416.

At operation 426, the selected AMF 406 may initiate a UE context transfer step by sending a UE context transfer request message (Namf_Communication_UEContextTransfer) to the old AMF 408 to retrieve UE context information of the UE 402.

At operation 428, the old AMF 408 responds with a UE context transfer response message (Namf_Communication_UEContextTransfer) back to the new AMF 406. In some aspects, the self-wakeup mode information may be passed between the AMF 406 and the old AMF 408 via the UE context transfer message and the UE context transfer response message.

At operation 430, the RAN 404, the AMF 406, and/or the AMF 408 refrain from waking up the UE 402 based on the self-wakeup mode indication.

At operation 432, based on the self-wakeup mode indication, the RAN 404, AMF 406, AMF 408, PCF 410, SMF 412, AUSF 414, and/or UDM 416 may store data (e.g., data, message, information, etc.) intended for the UE 402 while the UE 402 is in a sleep mode.

While the operations 430 and 432 are shown between the operations 428 and 434 in FIG. 4, it should be understand that the refraining operation 430 and storing operation 432 may be performed after receiving the self-wakeup mode indication and until receiving an indication from the UE 402 that the UE 402 is awake.

At operation 434, the AMF 405 may send an identity request step message to the UE 402 via the RAN 404 to request identity information from the UE 402.

At operation 436, the UE 402 responds with an identity response message back to the AMF 406 via the RAN 404, providing the requested identity information. The information may allow the AMF 406 to pass information to the UDM 416, indicating that identity-related information may be communicated to the UDM 416 as part of the registration procedure. In some aspects (not shown), the AMF 406 may pass the UE identity information to the UDM 416.

At operation 437, the UE 402 may independently and autonomously exit a sleep mode and self-wakeup based on internal logic, for example, based on the selected UE self-wakeup algorithm. In some aspects, the UE 402 may wake up depending on various power consumption requirements and communication needs. In some aspects, the UE 402 may wake up fully, in which case all radio and processing components of the device become active and operational. In some cases, the UE 402 may wake up partially, in which case only a subset of radio and processing components become active. In some cases, the device may wake up only an internal wake-up radio (WUR) installed in the device. The WUR may wake up to listen to the network, but does not have full radio functionality and, therefore, consumes very little power and enables low-power wake-up. In some aspects, the UE 402 wakes up based on timers to maintain network connectivity and registration status, while maximizing sleep duration for power conservation.

At operation 438, the UE 402 sends an indication to the RAN 404 indicating the UE 402 has woken up. In some aspects, the UE 402 sends a ping to the RAN 404 indicating the UE 402 has woken up. In some cases, the UE 402 sends a short data burst to the RAN 404 indicating the UE 402 has woken up. In some cases, the UE 402 sends a message to the RAN 404 indicating the UE 402 has woken up. In some aspects, the indication that the UE 402 has woken up may be transmitted using minimal power and bandwidth resources to preserve battery life. In some aspects, the UE 402 further indicates whether the UE 402 has fully woken up or has partially woken up.

The indication from the UE 402 at operation 438 acknowledges that the UE 402 is ready for communication. At operation 439, the network checks whether there is stored data that was intended for the UE 402 while the UE 402 was asleep.

At operation 440, if there is stored data waiting to be provided to the UE 402, then the UE 402 and the network (e.g., the RAN 404 and/or the AMF 406) establish one or more communication channels. In some aspects, the communication channels may be short data burst channels, a simple message channel, or full communication channels or sessions, depending on the amount and type of data and/or information to be transmitted to the UE 402.

At operation 442, the RAN 404 transmit the stored data to the UE 402. In some aspects (not shown), the UE 402 may also sends data or messages to the network after waking up and before returning to the sleep mode.

At operation 444, the UE 402 may re-enter the sleep mode after receiving the data from RAN 404 or if there no stored data awaiting transmission to the UE 402 (determined at operation 439) to conserve power until the UE's net self-initiated wakeup event based on the selected self-wakeup algorithm.

In some aspects (not shown), upon completion of transmitting the data to the UE 402, or when there is no stored data awaiting transmission to the UE 402 (determined at operation 439), the communications channels or sessions may be closed.

The network no-wakeup process enables stationary devices to manage their own wake-up schedules while allowing the network to buffer pending communications until the device independently awakens.

In some aspects, to further save power, the network can also provide the UE 402 with eDRX parameters so that the UE 402 can stop communicating for an extended period and/or go into sleep mode for an extended period before exiting sleep mode to receive communications from the network.

### Example Operations of a Wireless Device

FIG. 5 shows a method 500 for wireless communications by a wireless device, such as UE 104 of FIG. 1.

Optionally, method 500 includes, at operation 505, determining the wireless device is a stationary device.

In one aspect, determining the wireless device is a stationary device at operation 505 includes receiving signaling from the network entity configuring the wireless device with one or more mobility criteria associated with being the stationary device, and determining the wireless device is the stationary device based on the one or more mobility criteria.

In one aspect, the one or more specified mobility criteria include a relaxed measurement criterion for the stationary device.

Method 500 begins at operation 510 with sending a self-wakeup mode indication to a network entity.

In one aspect, sending the self-wakeup mode indication at operation 510, comprises sending the self-wakeup mode indication to the network entity in a registration request message.

In one aspect, sending the self-wakeup mode indication at operation 510 comprises sending the self-wakeup mode indication to the network entity in at least one of a radio capability element or a radio capability identifier element in the registration request message.

In one aspect, method 500 further includes, at operation 520, selecting the algorithm from a plurality of wakeup algorithms at the wireless device.

In one aspect, each of the plurality of wakeup algorithms is associated with an algorithm identifier, and method 500 further includes, at operation 530, transmitting the associated algorithm identifier of the selected algorithm to the network entity.

Method 500 then proceeds to operation 540 with independently waking up from a sleep mode.

In one aspect, independently waking up from the sleep mode at operation 520 comprises the wireless device waking up from the sleep based on algorithm of the wireless device without configuration or signaling from the network entity indicating the wake up.

In one aspect, method 500 further includes, at operation 550, transmitting another indication to the network entity indicating that the wireless device has woken up. In one aspect, method 500 further includes, at operation 560, in response to the indication that the wireless device has woken up (of operation 550), receiving, from the network entity, data intended for the wireless device while the wireless device was in the sleep mode.

In one aspect, transmitting the another indication at operation 550 comprises transmitting a ping to the network entity indicating that the wireless device has woken up.

In one aspect, transmitting the another indication at operation 550 comprises transmitting a short data burst to the network entity indicating that the wireless device has woken up.

In one aspect, transmitting the another indication at operation 550 comprises transmitting a message to the network entity indicating that the wireless device has woken up.

In one aspect, transmitting the another indication at operation 550 comprises transmitting an indication to the network entity that the wireless device has partially woken up.

In one aspect, transmitting the another indication at operation 550 comprises transmitting an indication to the network entity that the wireless device has fully woken up.

In one aspect, method 500 further includes establishing one or more communication channels with the network entity in response to sending the another indication to the network entity (at operation 550), wherein the receiving the data from the network entity (at operation 560) is via the one or more communication channels.

In one aspect, the one or more communication channels comprise short data burst channels or full communication channels.

In one aspect, the sending the self-wakeup mode indication to the network entity at operation 510 is in response to the wireless device being a stationary device.

In one aspect, the wireless device is configured or pre-configured as a stationary device.

Note that FIG. 5 is just one example of a method, and other methods including fewer, additional, or alternative steps are possible consistent with this disclosure.

### Example Operations of a Network Entity

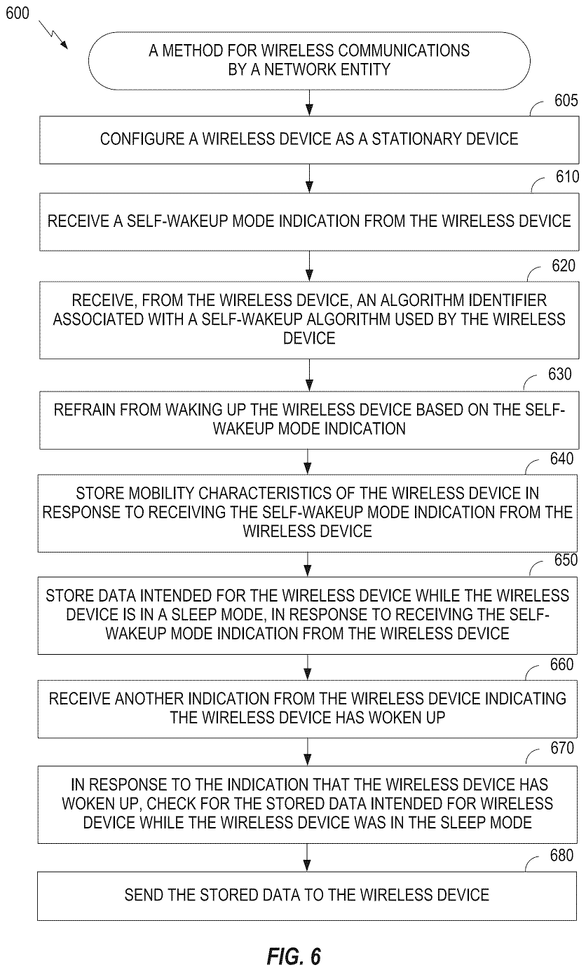

FIG. 6 shows a method 600 for wireless communications by a network entity, such as network entity 102 of FIG. 1.

Optionally, method 600 includes, at operation 605, configuring a wireless device as a stationary device.

In one aspect, method 600 further includes configuring the wireless device with one or more mobility criteria associated with being a stationary device.

In one aspect, the one or more specified mobility criteria include a relaxed measurement criterion for the stationary device.

Method 600 begins at operation 610 with receiving a self-wakeup mode indication from a wireless device.

In one aspect, receiving the self-wakeup mode indication from the wireless device at operation 610 comprises receiving the self-wakeup mode indication from the wireless device in a registration request message.

In one aspect, receiving the self-wakeup mode indication from the wireless device at operation 610 comprises receiving the self-wakeup mode indication from the wireless device in at least one of a radio capability element or a radio capability identifier element in the registration request message.

In one aspect, method 600 further includes at operation 620 receiving signaling from the wireless device indicating a self-wake up algorithm used by the wireless device.

Method 600 then proceeds to operation 630 with refraining from waking up the wireless device based on the self-wakeup mode indication (received at operation 610).

In one aspect, method 600 further includes at operation 640 storing mobility characteristics of the wireless device in response to receiving the self-wakeup mode indication from the wireless device (at operation 610).

In one aspect, the mobility characteristics include the self-wakeup mode indication.

In one aspect, the mobility characteristics include an indication the wireless device is a stationary device or is a mobile device.

In one aspect, method 600 further includes at operation 650, in response to the self-wakeup mode indication, storing data intended for the wireless device while the wireless device is in a sleep mode.

In one aspect, method 600 further includes at operation 660 receiving another indication from the wireless device indicating that the wireless device has woken up.

In one aspect, receiving the another indication at operation 660 comprises receiving a ping from the wireless device indicating that the wireless device has woken up.

In one aspect, receiving the another indication at operation 660 comprises receiving a short data burst from the wireless device indicating that the wireless device has woken up.

In one aspect, receiving the another indication at operation 660 comprises receiving a message from the wireless device indicating that the wireless device has woken up.

In one aspect, receiving the another at operation 660 indication comprises receiving an indication from the wireless device that the wireless device has partially woken up.

In one aspect, receiving the another indication at operation 660 comprises receiving an indication from the wireless device that the wireless device has fully woken up.

In one aspect, the method 600 further includes at operation 670, in response to the indication that the wireless device has woken up, checking for the stored data intended for the wireless device.

In one aspect, the method 600 further includes at operation 680 sending the stored data to the wireless device.

In one aspect, method 600 further includes establishing one or more communication channels with the wireless device in response to checking for the stored data intended for the wireless device, wherein the sending the stored data to the wireless device at operation 680 is via the one or more communication channels.

In one aspect, the one or more communication channels comprise short data burst channels or full communication channels.

Note that FIG. 6 is just one example of a method, and other methods including fewer, additional, or alternative steps are possible consistent with this disclosure.

### Example Clauses

Implementation examples are described in the following numbered clauses:
Clause 1: A method for wireless communications at a network entity, the method comprising: receiving a self-wakeup mode indication from a wireless device; and refraining from waking up the wireless device based on the self-wakeup mode indication.
Clause 2: The method of Clause 1, further comprising storing mobility characteristics of the wireless device in response to receiving the self-wakeup mode indication from the wireless device.
Clause 3: The method of any combination of Clauses 1-2, wherein the mobility characteristics include the self-wakeup mode indication.
Clause 4: The method of any combination of Clauses 1-3, wherein the mobility characteristics include an indication the wireless device is a stationary device or is a mobile device.
Clause 5: The method of any combination of Clauses 1-4, further comprising, in response to the self-wakeup mode indication, storing data intended for the wireless device while the wireless device is in a sleep mode.
Clause 6: The method of any combination of Clauses 5, further comprising: receiving another indication from the wireless device indicating that the wireless device has woken up; in response to the indication that the wireless device has woken up, checking for the stored data intended for the wireless device; and sending the stored data to the wireless device.
Clause 7: The method of any combination of Clauses 5-6, wherein receiving the another indication comprises receiving a ping from the wireless device indicating that the wireless device has woken up.
Clause 8: The method of any combination of Clauses 5-7, wherein receiving the another indication comprises receiving a short data burst from the wireless device indicating that the wireless device has woken up.
Clause 9: The method of any combination of Clauses 5-8, wherein receiving the another indication comprises receiving a message from the wireless device indicating that the wireless device has woken up.
Clause 10: The method of any combination of Clauses 5-9, wherein receiving the another indication comprises receiving an indication from the wireless device that the wireless device has partially woken up.
Clause 11: The method of any combination of Clauses 5-10, wherein receiving the another indication comprises receiving an indication from the wireless device that the wireless device has fully woken up.
Clause 12: The method of any combination of Clauses 5-11, further comprising establishing one or more communication channels with the wireless device in response to checking for the stored data intended for the wireless device, wherein the sending the stored data to the wireless device is via the one or more communication channels.
Clause 13: The method of any combination of Clauses 5-12, wherein the one or more communication channels comprise short data burst channels or full communication channels.
Clause 14: The method of any combination of Clauses 1-13, further comprising configuring the wireless device as a stationary device.
Clause 15: The method of any combination of Clauses 1-14, further comprising configuring the wireless device with one or more mobility criteria associated with being a stationary device.
Clause 16: The method of any combination of Clauses 15, wherein the one or more specified mobility criteria include a relaxed measurement criterion for the stationary device.
Clause 17: The method of any combination of Clauses 1-16, further comprising receiving signaling from the wireless device indicating a self-wake up algorithm used by the wireless device.
Clause 18: The method of any combination of Clauses 1-17, wherein receiving the self-wakeup mode indication from the wireless device comprises receiving the self-wakeup mode indication from the wireless device in a registration request message.
Clause 19: The method of any combination of Clauses 18, wherein receiving the self-wakeup mode indication from the wireless device comprises receiving the self-wakeup mode indication from the wireless device in at least one of a radio capability element or a radio capability identifier element in the registration request message.
Clause 20: A method for wireless communications at a wireless device, the method comprising: sending a self-wakeup mode indication to a network entity; and independently waking up from a sleep mode.
Clause 21: The method of Clause 20, wherein independently waking up from the sleep mode comprises the wireless device waking up from the sleep based on algorithm of the wireless device without configuration or signaling from the network entity indicating the wake up.
Clause 22: The method of any combination of Clauses 20-21, further comprising selecting the algorithm from a plurality of wakeup algorithms at the wireless device.
Clause 23: The method of any combination of Clauses 22, wherein each of the plurality of wakeup algorithms is associated with an algorithm identifier, further comprising transmitting the associated algorithm identifier of the selected algorithm to the network entity.
Clause 24: The method of any combination of Clauses 20-23, wherein sending the self-wakeup mode indication comprises sending the self-wakeup mode indication to the network entity in a registration request message.
Clause 25: The method of any combination of Clauses 24, wherein sending the self-wakeup mode indication comprises sending the self-wakeup mode indication to the network entity in at least one of a radio capability element or a radio capability identifier element in the registration request message.
Clause 26: The method of any combination of Clauses 20-25, further comprising: transmitting another indication to the network entity indicating that the wireless device has woken up; and in response to the indication that the wireless device has woken up, receiving, from the network entity, data intended for the wireless device while the wireless device was in the sleep mode.
Clause 27: The method of any combination of Clauses 26, wherein transmitting the another indication comprises transmitting a ping to the network entity indicating that the wireless device has woken up.
Clause 28: The method of any combination of Clauses 26-27, wherein transmitting the another indication comprises transmitting a short data burst to the network entity indicating that the wireless device has woken up.
Clause 29: The method of any combination of Clauses 26-28, wherein transmitting the another indication comprises transmitting a message to the network entity indicating that the wireless device has woken up.
Clause 30: The method of any combination of Clauses 26-29, wherein transmitting the another indication comprises transmitting an indication to the network entity that the wireless device has partially woken up.
Clause 31: The method of any combination of Clauses 26-30, wherein transmitting the another indication comprises transmitting an indication to the network entity that the wireless device has fully woken up.
Clause 32: The method of any combination of Clauses 26-31, further comprising establishing one or more communication channels with the network entity in response to sending the another indication to the network entity, wherein the receiving the data form the network entity is via the one or more communication channels.
Clause 33: The method of any combination of Clauses 26-32, wherein the one or more communication channels comprise short data burst channels or full communication channels.
Clause 34: The method of any combination of Clauses 20-33, wherein the sending the self-wakeup mode indication to the network entity is in response to the wireless device being a stationary device.
Clause 35: The method of any combination of Clauses 34, wherein the wireless device is configured or pre-configured as a stationary device.
Clause 36: The method of any combination of Clauses 34-35, further comprising: receiving signaling from the network entity configuring the wireless device with one or more mobility criteria associated with being the stationary device; and determining the wireless device is the stationary device based on the one or more mobility criteria.
Clause 37: The method of any combination of Clauses 36, wherein the one or more specified mobility criteria include a relaxed measurement criterion for the stationary device.
Clause 38: An apparatus, comprising: a memory comprising executable instructions; and one or more processors configured to execute the executable instructions and cause the apparatus to perform a method in accordance with any one of Clauses 1-19.
Clause 39: An apparatus, comprising: a memory comprising executable instructions; and one or more processors configured to execute the executable instructions and cause the apparatus to perform a method in accordance with any one of Clauses 20-37.
Clause 40: An apparatus, comprising means for performing a method in accordance with any one of Clauses 1-19.
Clause 41: An apparatus, comprising means for performing a method in accordance with any one of Clauses 20-37.
Clause 43: A non-transitory computer-readable medium comprising executable instructions that, when executed by one or more processors of an apparatus, cause the apparatus to perform a method in accordance with any one of Clauses 1-19.
Clause 43: A non-transitory computer-readable medium comprising executable instructions that, when executed by one or more processors of an apparatus, cause the apparatus to perform a method in accordance with any one of Clauses 20-37.
Clause 42: A computer program product embodied on a computer-readable storage medium comprising code for performing a method in accordance with any one of Clauses 1-19.
Clause 41: A computer program product embodied on a computer-readable storage medium comprising code for performing a method in accordance with any one of Clauses 20-37.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration. Further, a processor may be an application processor, host processor, processing units (such as central processing units (CPUs), graphics processing units (GPUs), neural processing units (NPUs) (also referred to as neural network processors or deep learning processors (DLPs)), data processing units (DPUs), associative processing units (APUs), tensor processing units (TPUs), language processing units (LPU), vision processing units (VPUs), quantum processing units (QPUs), processing blocks, or other discrete gate or transistor logic or circuitry (each of which may be generally referred to herein individually as “a processor” or “processor circuitry).

As used herein, “a processor,” “at least one processor” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. A group of processors collectively configurable or configured to perform a set of operations may include a first processor configurable or configured to perform a first operation of the set and a second processor configurable or configured to perform a second, different operation of the set. In some other examples, each of a group of processors may be configurable or configured to perform a same set of operations. Similarly, “a memory,” “at least one memory” or “one or more memories” generally refers to a single memory configured to store data and/or instructions, multiple memories configured to collectively store data and/or instructions.

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

In some cases, rather than actually transmitting a signal, an apparatus (e.g., a wireless node or device) may have an interface to output the signal for transmission. For example, a processor may output a signal, via a bus interface, to a radio frequency (RF) front end for transmission. Accordingly, a means for outputting may include such an interface as an alternative (or in addition) to a transmitter or transceiver. Similarly, rather than actually receiving a signal, an apparatus (e.g., a wireless node or device) may have an interface to obtain a signal from another device. For example, a processor may obtain (or receive) a signal, via a bus interface, from an RF front end for reception. Accordingly, a means for obtaining may include such an interface as an alternative (or in addition) to a receiver or transceiver.

While the present disclosure may describe certain operations as being performed by one type of wireless node, the same or similar operations may also be performed by another type of wireless node. For example, operations performed by a UE may also (or instead) be performed by a network entity (e.g., a BS or unit of a disaggregated BS). Similarly, operations performed by a network entity may also (or instead) be performed by a UE.

Further, while the present disclosure may describe certain types of communications between different types of wireless nodes (e.g., between a network entity and a UE), the same or similar types of communications may occur between same types of wireless nodes (e.g., between network entities or between UEs, in a peer-to-peer scenario). Further, communications may occur in reverse order than described.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c). Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b. Also, as used herein, the terms “has,” “have,” “having,” “comprise,” “comprising,” “include” and “including,” and derivatives thereof or similar terms are intended to be open-ended terms that do not limit an element that they modify (for example, an element “having” a also may have b).

As used herein, the term “determine” or “determining” encompasses one or more of a variety of actions. For example, “determining” can include one or more of calculating, computing, processing, deriving, detecting, estimating, investigating, looking up, inferring, ascertaining, measuring, resolving, selecting, obtaining, choosing, identifying, interpreting, demodulating, decoding, reading, establishing, forming, or generating, among other examples. In some examples, determining can involve a processing system performing some type of calculating, computing, deriving, estimating, inferring, ascertaining, resolving, predicting, or other processing to obtain one or more numerical values, sets, elements, or other information or results. In some examples, determining can involve a processing system identifying, looking up, investigating, or otherwise obtaining some type of value, set, element, or other information or result from a table, data structure, database, or an implementation of memory, such as from a larger set of values, sets, or elements or other information or results. In some examples, determining can involve a processing system identifying, interpreting, demodulating, decoding, detecting, reading, or otherwise obtaining some type of value, set, element, or other information or result signaled in, for example, a received wireless signal. In some examples, determining can involve a processing system performing a measurement, such as on a received signal.

As used herein, the phrase “based on” is equivalent to “based at least in part on” and indicates a non-limiting relationship between elements “a” and “b.” In some aspects, a′ (which may be a variation or example of a) may be responsive to or in response to b′ (which may be a variation or example of b), such as if condition c is met. In some other aspects, a″ (which may be a variation or example of at least one of a or a′) may be associated with b″ (which may be a variation or example of at least one of b or b′). In some further aspects, a″′ (which may be a variation or example of at least one of a or a′ or a″) may be determined (or any of the other actions encompassed by usage of the word “determining” as described above) in accordance with b″′ (which may be a variation or example of at least one of b or b′ or b″). Furthermore, what follows the phrase “in accordance with,” “as a function of,” “in response to,” “responsive to,” or “using” is not necessarily the focal point or primary factor associated with the limitation preceding the phrase. For example, the phrases “in accordance with,” “based on,” “based at least in part on,” “as a function of,” “in response to,” “responsive to,” “associated with,” or “using” are not to be construed as a reference to a closed set of conditions, factors, criteria, elements, components or actions, among other examples.

As used herein, “satisfying a threshold” may, depending on the context, refer to a value being greater than the threshold, greater than or equal to the threshold, less than the threshold, less than or equal to the threshold, equal to the threshold, or not equal to the threshold.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for wireless communications at a network entity, the method comprising:
receiving a self-wakeup mode indication from a wireless device; and
refraining from waking up the wireless device based on the self-wakeup mode indication.

2. The method of claim 1, further comprising storing mobility characteristics of the wireless device in response to receiving the self-wakeup mode indication from the wireless device.

3. The method of claim 2, wherein the mobility characteristics include the self-wakeup mode indication.

4. The method of claim 2, wherein the mobility characteristics include an indication the wireless device is a stationary device or is a mobile device.

5. The method of claim 1, further comprising, in response to the self-wakeup mode indication, storing data intended for the wireless device while the wireless device is in a sleep mode.

6. The method of claim 5, further comprising:
receiving another indication from the wireless device indicating that the wireless device has woken up;
in response to the indication that the wireless device has woken up, checking for the stored data intended for the wireless device; and
sending the stored data to the wireless device.

7. The method of claim 6, wherein receiving the another indication comprises receiving a ping from the wireless device indicating that the wireless device has woken up.

8. The method of claim 6, wherein receiving the another indication comprises receiving a short data burst from the wireless device indicating that the wireless device has woken up.

9. The method of claim 6, wherein receiving the another indication comprises receiving a message from the wireless device indicating that the wireless device has woken up.

10. The method of claim 6, wherein receiving the another indication comprises receiving an indication from the wireless device that the wireless device has partially woken up.

11. The method of claim 6, wherein receiving the another indication comprises receiving an indication from the wireless device that the wireless device has fully woken up.

12. The method of claim 6, further comprising establishing one or more communication channels with the wireless device in response to checking for the stored data intended for the wireless device, wherein the sending the stored data to the wireless device is via the one or more communication channels.

13. The method of claim 12, wherein the one or more communication channels comprise short data burst channels or full communication channels.

14. The method of claim 1, further comprising configuring the wireless device as a stationary device.

15. The method of claim 1, further comprising configuring the wireless device with one or more mobility criteria associated with being a stationary device.

16. The method of claim 15, wherein the one or more specified mobility criteria include a relaxed measurement criterion for the stationary device.

17. The method of claim 1, further comprising receiving signaling from the wireless device indicating a self-wake up algorithm used by the wireless device.

18. The method of claim 1, wherein receiving the self-wakeup mode indication from the wireless device comprises receiving the self-wakeup mode indication from the wireless device in a registration request message.

19. The method of claim 18, wherein receiving the self-wakeup mode indication from the wireless device comprises receiving the self-wakeup mode indication from the wireless device in at least one of a radio capability element or a radio capability identifier element in the registration request message.

20. A method for wireless communications at a wireless device, the method comprising:
sending a self-wakeup mode indication to a network entity; and
independently waking up from a sleep mode.

21. The method of claim 20, wherein independently waking up from the sleep mode comprises the wireless device waking up from the sleep based on algorithm of the wireless device without configuration or signaling from the network entity indicating the wake up.

22. The method of claim 21, further comprising selecting the algorithm from a plurality of wakeup algorithms at the wireless device.

23. The method of claim 22, wherein each of the plurality of wakeup algorithms is associated with an algorithm identifier, further comprising transmitting the associated algorithm identifier of the selected algorithm to the network entity.

24. The method of claim 20, wherein sending the self-wakeup mode indication comprises sending the self-wakeup mode indication to the network entity in a registration request message.

25. The method of claim 24, wherein sending the self-wakeup mode indication comprises sending the self-wakeup mode indication to the network entity in at least one of a radio capability element or a radio capability identifier element in the registration request message.

26. The method of claim 20, further comprising:
transmitting another indication to the network entity indicating that the wireless device has woken up; and
in response to the indication that the wireless device has woken up, receiving, from the network entity, data intended for the wireless device while the wireless device was in the sleep mode.

27. The method of claim 26, wherein transmitting the another indication comprises transmitting a ping to the network entity indicating that the wireless device has woken up.

28. The method of claim 26, wherein transmitting the another indication comprises transmitting a short data burst to the network entity indicating that the wireless device has woken up.

29. The method of claim 26, wherein transmitting the another indication comprises transmitting a message to the network entity indicating that the wireless device has woken up.

30. The method of claim 26, wherein transmitting the another indication comprises transmitting an indication to the network entity that the wireless device has partially woken up.

31. The method of claim 26, wherein transmitting the another indication comprises transmitting an indication to the network entity that the wireless device has fully woken up.

32. The method of claim 26, further comprising establishing one or more communication channels with the network entity in response to sending the another indication to the network entity, wherein the receiving the data form the network entity is via the one or more communication channels.

33. The method of claim 32, wherein the one or more communication channels comprise short data burst channels or full communication channels.

34. The method of claim 20, wherein the sending the self-wakeup mode indication to the network entity is in response to the wireless device being a stationary device.

35. The method of claim 34, wherein the wireless device is configured or pre-configured as a stationary device.

36. The method of claim 34, further comprising:
receiving signaling from the network entity configuring the wireless device with one or more mobility criteria associated with being the stationary device; and
determining the wireless device is the stationary device based on the one or more mobility criteria.

37. The method of claim 36, wherein the one or more specified mobility criteria include a relaxed measurement criterion for the stationary device.

38. A network entity, comprising:
memory storing computer executable code; and
at least one processor configured to execute the computer executable code to cause the network entity to:
receive a self-wakeup mode indication from a wireless device; and
refrain from waking up the wireless device based on the self-wakeup mode indication.
